(19) United States
(12) Patent Application Publication
(10) Pub. No.: US 2005/0230025 A1
(43) Pub. Date: Oct. 20, 2005

(54) Method and apparatus for welding reinforced polymers

(76) Inventors: Philip J. Bates, Ontario (CA); Brenda D. Tucker, Ontario (CA); Robert W. Tucker, Ontario (CA); Vasileios Sidiropoulos, Ontario (CA)

Correspondence Address: Stephen J Scribner;Parteq Innovations, Room 1625 Biosciences Complex, Queen's University, Kingston Ontario K7L 3N6 Canada, CA

(21) Appl. No.: 10/513,166

(22) PCT Filed: May 2, 2003
(86) PCT No.: PCT/CA03/00666

§ 371 Date: Jun. 13, 2005

Related U.S. Application Data
(60) Provisional application No. 60/377,229, filed on May 3, 2002.

(51) Int. Cl. B32B 31/00

(52) U.S. Cl. 156/73.4; 156/580.1

(57) ABSTRACT

This invention relates to a method and apparatus for increasing the strength of a particle-reinforced polymer weld joint, comprising compressing and elongating the molten film of polymer at the weld plane of a joint, such that all or a portion of the reinforcing particles in the molten film are reoriented with their longitudinal axes not parallel to the weld plane. In a preferred embodiment, the molten film is oscillated in a direction substantially perpendicular to the weld plane.

### FIELD OF THE INVENTION

This invention relates to a method and apparatus for welding reinforced polymer parts. More specifically, this invention relates to a method and apparatus for increasing the strength of welded joints of reinforced polymer parts.

### BACKGROUND OF THE INVENTION

In many consumer, automotive, and industrial applications, metal components are increasingly being replaced with plastic components. This has led to increased demands on the thermo-mechanical properties of plastics. For example, automotive polymer air intake manifolds may be subjected to stresses up to 14 MPa over all operating conditions, including temperatures that can range from −40° C. to +130° C. (Lee, 1997). However, extreme temperatures have significant negative effects on a polymer's mechanical properties. At low temperatures, fatigue failure is a concern, while at high temperatures excessive material creep is an issue. For these reasons, many demanding applications require the use of reinforced plastics. Such plastics consist of a polymer matrix to which has been added a reinforcing material, such as glass fibers or mineral particles.

The manufacture of complex components from a polymer often requires that the components be assembled from two or more parts. Joining of the parts must create joints able to resist stresses in the component. In most situations linear vibration welding is the most viable, cost-effective way to assemble plastic components. Linear vibration welding involves bringing parts to be welded together under a clamping pressure, and vibrating one of the parts at a frequency of about 200 Hz over an amplitude of about 1 mm. Friction and viscous dissipation melts polymer at the weld interface. Molten polymer is forced from the interface as the two parts come together, referred to as meltdown. After a preset meltdown distance or time is reached, the vibration is stopped. The polymer at the welded joint then cools and solidifies. Currently, under optimized low pressure welding, the weld strength of a butt joint of unreinforced polymer is equivalent to the strength of unwelded (i.e., bulk) material.

However, for a fiber-reinforced polymer, the optimized weld strength is significantly lower than that of unwelded material, and is closer to the strength of the resin matrix. Thus, for reinforced polymers, a limitation of vibration welding is the weakness of the welded joint relative to the bulk material.

### SUMMARY OF THE INVENTION

According to one aspect of the invention there is provided a method for increasing the strength of a particle-reinforced polymer weld joint, comprising: providing a molten film of polymer at a weld plane of the joint; and reorienting all or a portion of the reinforcing particles in the molten film such that a longitudinal axis of said reinforcing particles is not parallel to the weld plane; wherein said reorienting of particles increases the strength of the welded joint.

According to another aspect of the invention there is provided a method for increasing the strength of a particle-reinforced polymer weld joint, comprising: providing a molten film of polymer at a weld plane of the joint; and increasing randomness of orientation of all or a portion of the reinforcing particles in the molten film; wherein said increased randomness of particle orientation increases the strength of the welded joint.

In one embodiment, the molten film is provided by vibration welding. In a further embodiment, the molten film is provided by linear vibration welding. In yet further embodiments, the molten film is provided by spin welding, hot plate welding, laser welding, resistance welding, or induction welding.

In one embodiment, the reinforcing particles are reoriented by cycling weld pressure applied to said molten film. In a further embodiment, the reinforcing particles are reoriented by providing an oscillation to the molten film, the oscillation being substantially perpendicular to the weld plane.

In various embodiments of the invention, the polymer is selected from amorphous polymers, semi-crystalline polymers, and blends thereof. In various embodiments, the reinforcing particle is selected from organic particles, inorganic particles, and a combination thereof.

According to another aspect of the invention, there is provided an apparatus for vibration welding a joint between particle-reinforced polymer parts, comprising: a vibrator for vibrating at least one polymer part along a common interface of said polymer parts such that a molten film of polymer is provided at a weld plane of the joint; and a z-direction actuator for compressing and elongating the molten film.

In accordance with this aspect of the invention, compressing and elongating the molten film reorients all or a portion of the reinforcing particles in the molten film such that a longitudinal axis of said reinforcing fibers is not parallel to the weld plane.

In one embodiment, the z-direction actuator oscillates the molten film perpendicular to the weld plane.

In various embodiments, the polymer is selected from amorphous polymers, semi-crystalline polymers, and blends thereof. In further embodiments, the reinforcing particle is selected from organic particles, inorganic particles, and a combination thereof.

According to another aspect of the invention there is provided an improved method of vibration-welding reinforced polymer parts, the improvement comprising providing an oscillation to a molten film in a weld plane of the parts being welded, wherein the oscillation is substantially perpendicular to the weld plane of the parts.

According to another aspect of the invention there is provided an improved apparatus for welding reinforced polymer parts, the improvement comprising a z-direction actuator for oscillating at least one of the parts being welded in a direction substantially perpendicular to the weld plane. In one embodiment, the apparatus is a linear vibration welder. In other embodiments, the apparatus is selected from the group consisting of an orbital vibration welder, a spin welder, a hot plate welder, a laser welder, a resistance welder, and an induction welder.

### BRIEF DESCRIPTION OF THE DRAWINGS

The invention will now be described, by way of example, with reference to the accompanying drawings, wherein:

FIGS. 1A and 1B are schematic diagrams of two parts before and after linear vibration welding. The x, y, and z planes are identified by the coordinate system shown at the right of FIG. 1A.

FIG. 2 shows a typical meltdown-time profile for a welded butt joint wherein the welded parts are of similar materials.

FIG. 3 is a plot of butt weld tensile strength of PA 6 (open circles) and PA 6 33% GF (filled circles) as a function of weld pressure. The tensile strength of unwelded PA 6 is shown for reference (dashed line). Each data point is based on 10 test pieces with one standard deviation.

FIG. 4 is a plot of butt weld tensile strength of PA 66 (open circles) and PA 66 33% GF (filled circles) as a function of weld pressure. The tensile strength of unwelded PA 66 is shown for reference (dashed line). Each data point is based on 10 test pieces with one standard deviation.

FIG. 5 is a schematic diagram of a linear vibration welder to which stepper motors have been added for oscillation of the platen in the z-direction (see arrows) in accordance with the invention.

FIG. 6 is a plot of weld strength of PA 6 33% GF as a function of number of z-direction oscillations at three trigger points, using the welder depicted in FIG. 5. Stepper amplitude 127 μm, weld frequency 212.5 Hz, weld peak-to-peak amplitude 1.78 mm, weld pressure 1.4 MPa, and meltdown 2 mm. Each data point is the average of 10 test pieces with one standard deviation.

FIG. 7 is a plot of weld strength of PA 6 33% GF as a function of stepper amplitude, using the welder depicted in FIG. 5. Number of oscillations was 5, weld frequency 212.5 Hz, weld peak-to-peak amplitude 1.78 mm, weld pressure 1.4 MPa, trigger point 1.7 mm, and meltdown 2 mm. Each data point is the average of 10 test pieces with one standard deviation.

FIGS. 8A and 8B are plots of tensile strength versus weld pressure for baseline welds (open circles) and welds subjected to z-direction oscillation (filled circles) for PA 6 33% GF and PA 66 33% GF, respectively. Welds were oscillated for 5 cycles with a stepper amplitude of 127 μm and trigger point at 1.7 mm of meltdown. Each data point is the average of 10 test pieces with one standard deviation.

### DETAILED DESCRIPTION OF THE INVENTION

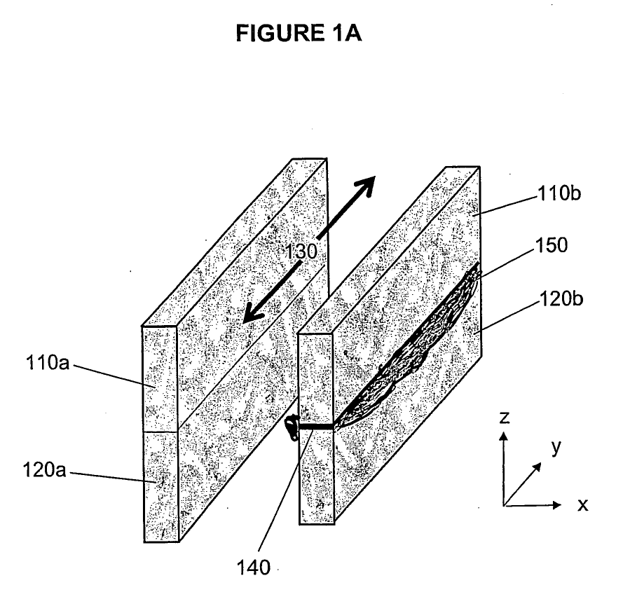

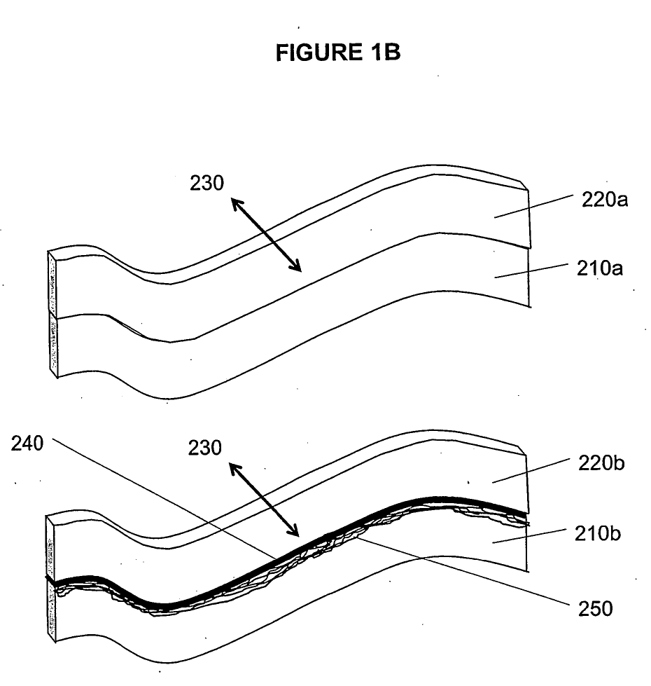

One of the more common polymer welding techniques is vibration welding. Most vibration welding is carried out using the standard linear vibration welding technique, illustrated schematically in FIGS. 1A and 1B. FIG. 1A shows two parts 110a and 120a prior to welding, and the same parts 110b and 120b after welding. The two parts are brought together under a clamping force; this force divided by the common surface area between the parts is referred to as the weld pressure. As shown in FIG. 1A, one part 110a is then vibrated parallel to the common interface of the two parts; that is, in the x or y plane of the weld joint, at a frequency of about 100 to 250 Hz at an amplitude of about 1 to 2 mm, while the second part 120a is prevented from moving in the direction of vibration. In the example of FIG. 1A, the vibration direction is shown by the arrow 130 and is in the y plane or direction of the weld joint (see the x,y,z coordinate system depicted in FIG. 1A). Friction and viscous dissipation at the interface melts the polymer and creates a film of molten material 140 between the two parts. The weld pressure forces molten polymer from the film, referred to as flash 150, and the two parts come together. The distance that the two parts travel perpendicular to the weld plane (i.e., in the z-direction) is referred to as the meltdown. A weld is formed at the interface when the vibratory motion is stopped at a preset target meltdown and the film of molten material between the two parts 1 10b and 1 20b solidifies. This type of welding operation is often referred to as “weld-by-distance”. The vibratory motion can also be stopped after a specified time in “weld-by-time” operation. As well as meltdown, other main process parameters are weld frequency, peak-to-peak amplitude of vibration, and weld pressure. The entire process takes place in a matter of a few seconds.

In FIG. 1A the weld plane occupies only the x and y planes, and hence is flat, or planar. FIG. 18 is similar to FIG. 1A in that it shows two parts 210a and 220a before linear vibration welding, and the same parts 210b and 220b after welding. However, in FIG. 1B the weld plane occupies the x, y, and z planes, such that it is not planar (coordinate system not shown). The vibration direction is in the direction direction of the arrow 230. Reference numerals 240 and 250 refer to the molten film and the flash, respectively.

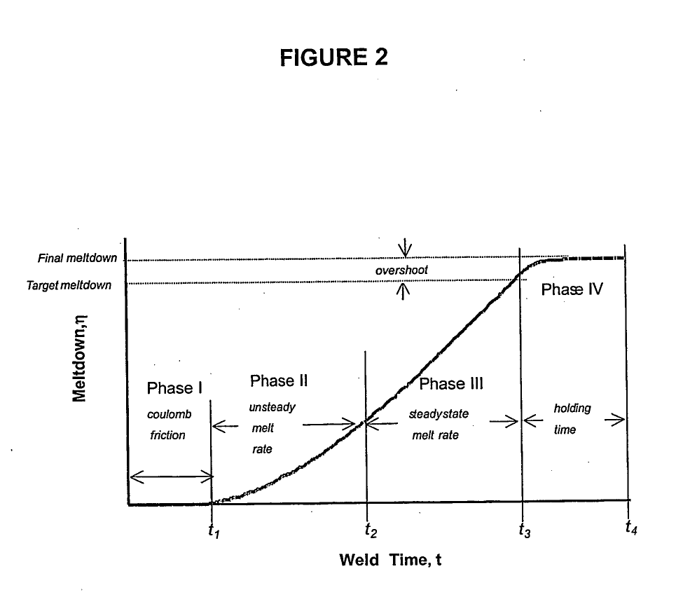

Stokes (1 988a,b,c) characterized the welding process for a butt joint and identified four distinct phases. A representative meltdown versus time curve showing the four phases is shown in FIG. 2. In phase I, heat generated through coulomb friction raises the temperature of the interfacial area of the butt joint to the glass transition temperature of amorphous thermoplastics, or the crystalline melting point of semi-crystalline plastics, at which point the polymer can undergo viscous flow.

In phase II, a small molten polymer film starts to develop at the interface between the parts. The heat required for continued melting of the polymer is thus generated through viscous dissipation of the kinetic energy rather than frictional dissipation. Phase II is also characterized by the beginning of molten polymer flow (flash) from the film due to the applied pressure. Flash is responsible for meltdown. Because of the small gap between the two solid parts, a high shear rate is created. The high shear rate leads to a high rate of energy generation and causes a high rate of melting. The quantity of molten polymer created is larger than the amount of molten polymer that can flow out of the thin film between the parts. The thickness of the molten film thus increases between the two parts in phase II.

As the film grows in phase II, the rate of energy dissipation decreases and the rate of melt flow from the weld increases. Phase III is reached when the melt generation rate equals the rate of polymer flow from the film. The film thickness and the meltdown rate are thus theoretically constant in phase III.

The last phase of the weld process, phase IV, starts as the vibration is stopped. This happens when a preset target meltdown is reached (weld by distance) or after a preset time (weld by time). The duration of phase IV is known as the “holding time” (e.g., holding time to a value equal to half the vibration time). During phase IV, the weld pressure is maintained and therefore some molten polymer continues to be expelled as flash from the molten film until the film has completely solidified. The molten film thickness thus decreases in phase IV as there is theoretically no further melting caused by viscous dissipation. This further meltdown distance that occurs during phase IV is referred to as “overshoot”.

The duration of all of these four phases of the process is several seconds. The time is dependent on several factors, including the material's physical and rheological properties, and the welding parameters, which include pressure, amplitude, frequency, target meltdown (or weld time), and holdtime. As weld pressure increases, the time decreases, and the weld cycle time can be reduced significantly with a higher amplitude and frequency. It is therefore clear that high pressures, frequencies, and amplitudes drive low cycle times.

The quality of a weld joint has been shown to be affected, in varying degrees, by the weld pressure, weld amplitude, weld frequency, and weld meltdown. Under optimum conditions, the weld strength of a joint in unreinforced polymer can be equivalent in strength to the base resin matrix strength. For example, the unwelded bulk strength of an unreinforced polyamide (PA), nylon 6 or PA 6, is about 82 MPa and the reported weld strength is about 81 MPa (Kagan, 2001; Stevens, 1997; 1999).

The parameter that has the most influence on the weld strength appears to be the weld pressure. For the most part, as weld pressure is increased, the strength of the joint decreases (Kagan, 1996; Froment, 1995; Potente, 1993a, 1993b; Schlarb, 1989; Giese, 1993). Although at lower pressures the weld strength is higher, the lower pressure leads to longer weld cycle times. Pressure profiling can compensate for the trade-off between weld cycle time and optimized joint strength. For example, a two pressure-stage welding technique can be employed, wherein there is a high pressure at the beginning of the cycle, allowing rapid generation of heat and molten polymer, followed by a reduced pressure at the end of the cycle, allowing the maximum strength to be reached. This modified process requires only half the time of the conventional process, where one low weld pressure is applied throughout the weld cycle to achieve the same strength.

The addition of particulate reinforcing material to neat polymer is a common means of modifying polymer properties such as strength. Glass fibers are commonly used in various forms such as continuous bundles of fibers, woven fabrics, and chopped fibers. Strength improvement depends on filler/reinforcement level, type, aspect ratio, and orientation.

When vibration welding glass fiber (GF) reinforced polyamides (PA) such as nylon 6 GF (PA 6 GF) and nylon 66 GF (PA 66 GF), several studies have reported that the weld strength corresponds approximately to the strength of the resin matrix rather than the bulk composite material strength (Gehde, 1997; Stokes 1991). Thus, the strength benefit of the reinforcing fiber is lost in the welded joint.

It has been suggested that the low weld strength of PA 66 GF, in comparison to its bulk strength, is due to reduced randomness of orientation of the glass fibers in the weld joint. That is, during welding the fibers become preferentially oriented into the x-y weld plane, with fewer fibers oriented in the z-direction (i.e., out of the weld plane, see FIG. 1A). As a result, most of the fibers are at right angles to the direction of loading during tensile strength testing, such that the fibers assume very little reinforcing function (PA 6 GF and PA 66 GF: Kagan, 1996; MacDonald, 2001; modified polyphenylene oxide: Stokes 1991; polyethersulfone: Potente, 1993).

The present invention is based, at least in part, on the discovery that during welding the reinforcing particles in the molten film of a reinforced polymer can be re-oriented out of the weld plane, such that the strength of the welded joint is substantially increased.

As used herein, the term “weld plane” refers to the common interface (i.e., common surface area) of polymer parts at the weld joint. As shown schematically in FIG. 1A, the weld plane can be substantially planar (i.e., flat), such that it occupies, for example, the x and y planes, shown in FIG. 1A. However, the weld plane can also non-planar, such as, for example, when the common surface area of the parts being welded is curved or irregularly-shaped, such that it occupies the x,y, and z planes, as shown in FIG. 1B. A reinforcing particle that is oriented in the weld plane has its longitudinal axis substantially parallel to or aligned with the weld plane.

As used herein, the terms “z-direction”, “z-plane”, “perpendicular to the weld plane”, and “normal to the weld plane” are interchangeable and refer to an axis, plane, or direction substantially perpendicular or normal to the weld plane, as shown schematically in FIG. 1.

As used herein, the term “out of the weld plane” refers to a direction or orientation that is not parallel to the weld plane. A reinforcing particle that is oriented out of the weld plane is oriented such that its longitudinal axis (i.e., its longest axis) is not substantially parallel to the weld plane. It is to be understood that orientation of a reinforcing particle out of the weld plane encompasses not only orientation of a particle with its longitudinal axis substantially perpendicular to the weld plane, but also orientation of a particle diagonally, such that its longitudinal axis has a component in the z-direction and a component in at least one of the x- and y-directions. The invention thus provides for increased randomness in reinforcing particle orientation in a weld joint, relative to a joint welded with a standard welding process.

In accordance with the invention, various strategies aimed at re-orienting reinforcing particles out of the weld plane during linear vibration welding were investigated. These strategies involved modifying the standard linear vibration welding process during phase III or phase IV of the process (see FIG. 2), and included:
(1) Creating a large molten film thickness to reduce shear stresses in the vibration direction and thus permit particles to orient themselves more randomly during welding, by:
   (1a) Elimination of the overshoot in phase IV to preserve the thickness of the molten film developed during phase III; or
   (1b) Removal of the weld pressure while welding in phase Ill to stop expelling molten polymer from the film and thus potentially increase the molten film thickness.
(2) Deliberately reorienting reinforcing particles out of the weld plane through the use of an elongational strain in the z-direction, by:
   (2a) Elongation of the molten film perpendicular to the weld plane in phase IV, just prior to solidification, to induce reorientation of the particles in the direction of the applied strain, or
   (2b) Oscillation of the molten film perpendicular to the weld plane in phase III, to induce particle orientation in a more random direction, both in and out of the weld plane.

As described below and in the Working Examples, it was found that the strategy of deliberately reorienting the particles out of the weld plane and into the z-direction through the use of elongational strains in the z-direction was successful in improving weld joint strength and randomness of particle orientation in the welded polymer. Thus, in accordance with the invention, reinforcing particles are reoriented out of the weld plane by providing an elongational strain in the z-direction during the welding process. In one embodiment, the z-direction strain is provided as a single elongational strain of the molten film prior to solidification of the weld joint in phase IV. As described in Example 4, below, this embodiment is expected to provide satisfactory results upon optimization of the rate at which the z-direction strain is applied. In a preferred embodiment, the z-direction strain is provided as one or more z-direction oscillations of the molten film, by oscillating one of the welded parts relative to the other welded part. From analyses of the results of this technique, it is believed that the oscillations provide cycling of weld pressure and both elongation and compression of the molten film. It is believed that this produces a mixing action within the molten film which enhances randomization of the reinforcing particles in the molten film and the weld plane.

Thus, according to one aspect of the invention, there is provided a method of increasing the strength of a particle-reinforced polymer weld joint, comprising re-orienting all or a portion of the reinforcing particles in the molten film out of the weld plane during welding. The method comprises providing to the molten film an oscillation in a direction substantially perpendicular to the weld plane. It will be appreciated that the term “substantially perpendicular” is intended to include z-direction oscillations or forces (i.e., elongation and compression) that are 90° to the weld plane as well as deviations therefrom; that is, angles other than 90° to the weld plane which provide for a greater portion of the reinforcing particles to be oriented out of the weld plane than when a standard welding process is used.

As shown below, for high weld pressures (e.g., greater than 2 MPa), the introduction of an oscillation normal to the weld plane during welding reorients the reinforcing particles out of the weld plane. This results in a strength equivalent to that achieved under low pressure welding conditions. For example, weld tensile strengths of PA 6 33% GF and PA 66 33% GF are improved by at least 20% with such oscillation. The optimal conditions are related to factors such as a combination of trigger position, number of z-direction oscillation cycles that allows oscillation to end as close as possible to the meltdown set-point, and amplitude of z-direction oscillation, and these can be determined for a particular task using no more than routine experimentation.

The minimum z-direction oscillation frequency is determined by the minimum number of z-direction oscillations to be completed in the available time (in most cases the available time is the meltdown time during phase III of the welding process (see FIG. 2)). For example, for a single z-direction oscillation and a phase III meltdown time of 2 seconds, the minimum oscillation frequency is 0.5 Hz. A maximum z-direction oscillation frequency of about 1 kHz is expected to be suitable, and such higher frequency would permit a greater number of cycles to be completed in a shorter period of time. Preferably, the z-direction oscillation frequency is in the range of about 2 Hz to about 500 Hz. In the present study the frequency of z-direction oscillation was limited by the available equipment to about 2.5 Hz, and the number of oscillation cycles was varied from about 1 to 50. The maximum number of z-direction oscillations that could be completed within the time available was limited to about 50 by the low oscillation frequency.

Generally, the minimum z-direction oscillation peak-to-peak amplitude is about equal to the diameter or thickness of the reinforcing particles, e.g., about 20 μm, and the maximum oscillation amplitude is below that which might interfere with the welding process, e.g., about 2 mm. Preferably, the oscillation amplitude is in the range of about 20 μm to 1 mm, more preferably about 50-μm to 500 μm.

The invention is applicable to welding of any reinforced thermoplastic material. Such materials can be generally classified as amorphous polymers, semi-crystalline polymers, and blends of amorphous and semi-crystalline polymers. Examples of amorphous polymers include, but are not limited to, polystyrene, polyvinylchloride, acrylonitrile-butadienne-styrene, acrylonitrile-styrene-acrylic, polycarbonate (PC), modified polyphenylene oxide (M-PPO), and polyetherimide. Examples of semi-crystalline polymers include, but are not limited to, polyolefins such as polypropylene and polyethylene, poly(butylene terephthalate), and polyamides (PA) such as nylon 6 (PA 6) and nylon 66 (PA 66). Examples of blends of amorphous and semi-crystalline polymers include, but are not limited to, modified polyphenylene oxide/polyamide blends, polycarbonate/acrylonitrile-butadiene-styrene blends, and polycarbonate/poly(butylene terephthalate) blends. It will be appreciated that the parts being welded in accordance with the invention need not be of the same polymer material, nor is it necessary that each of the parts being welded is reinforced. That is, the invention is applicable to situations where only one of the parts being welded is a reinforced polymer.

As used herein, the terms “reinforcing particle(s)” and “reinforcing fiber(s)” refer to any particulate reinforcing material added to a polymer to improve its strength. Such reinforcing particles have a large surface area-to-volume ratio, and preferably are, for example, rod-, fiber-, or platelet-shaped. Reinforcing material can be either organic, such as carbon and aramide (Keviar®), or inorganic, such as graphite, glass, ceramic, and mineral (e.g., clay, mica). Glass fibers are commonly used in various forms such as continuous bundles of fibers, woven fabrics, and chopped fibers. The strength improvement imparted to the polymer depends on the ratio of polymer to reinforcing material, and the type, aspect ratio, and orientation of the reinforcing particles.

Reinforced polymer parts to be welded according to the invention may be produced by any process known in the art, such as, for example, injection moulding, extrusion, compression moulding, thermoforming, and machining (e.g., from a blank). Many reinforced polymer parts subjected to welding are produced by injection moulding. A consequence of injection moulding is that the reinforcing particles become preferentially aligned in the direction of polymer flow during moulding. Such alignment of particles is caused by drag exerted on the particles by flowing viscous molten polymer, and the extent of the alignment is a function of factors such as injection speed, part dimensions, and rheological characteristics of the molten polymer. The alignment negatively affects strength of the reinforced polymer material, and of any welded joint. The invention overcomes the decreased strength of welded joints of injection moulded polymers, by substantially increasing randomness of reinforcing particle orientation in the vicinity of the welded joint.

In commercial and industrial settings vibration welding is typically carried out at high pressure to reduce the cycle time and to ensure that parts being welded are mated properly. For such manufacturing operations, a welding process with z-direction oscillation as described herein will provide for improved weld strength while maintaining the high pressure and associated rapid cycle time benefits. Indeed, industrial welders equipped with hydraulic moving platens rather than pneumatic platens can be easily modified by adding an oscillating hydraulic actuator to oscillate the platen. The invention will also allow operations using low weld pressure to use higher pressure with no strength penalty, and gain the advantage of a faster cycle time. As described herein, with z-direction oscillations the weld-joint strength was not compromised after increasing the weld pressure by a factor of five, and it is expected that yet higher pressures can be used while achieving strength which could otherwise only be achieved with a low pressure weld.

The invention is applicable to any polymer welding process that provides a molten film of polymer at the weld plane of the joint. Vibration welding, such as linear vibration welding, is one such process that typically involves vibrating one or more of the parts being welded in the x or y direction, relative to the weld plane (see FIG. 1A), at a frequency of about 50 to 500 Hz and a peak-to-peak amplitude of about 0.5 to 5 mm. Other polymer welding processes to which the invention is applicable include, but are not limited to, orbital vibration welding, spin welding, hot plate welding, laser welding, resistance welding, and induction welding, wherein a molten film at the weld plane of the polymer parts being joined is established by orbital vibration, rotation, hot plate, laser irradiation, electrical resistance heating, or magnetic field induction heating, respectively, and the parts are then joined under pressure and held until the weld joint cools and solidifies. When reinforced polymers are joined using such processes, applying an oscillation normal to the weld plane, as described herein, increases randomness of reinforcing particle orientation in the weld joint and thus increases strength of the joint.

According to another aspect of the invention there is provided an apparatus for vibration welding particle-reinforced polymer parts, wherein the apparatus provides for reorienting of all or a portion of the reinforcing particles out of the weld plane. The apparatus thus provides for increased strength of the welded joint, relative to that which can be achieved using a standard vibration welder. The apparatus comprises a clamping arrangement for holding the polymer parts during welding, a vibrating head for linear or orbital vibrating of at least one of the parts parallel to the common interface of the parts, so as to generate a molten film at the weld plane, and a mechanism for providing tension and/or compression forces to the molten film perpendicular to the weld plane. In a preferred embodiment, the mechanism provides tension and compression to the molten film by oscillating at least one of the parts in the z-direction. In various embodiments, the mechanism comprises a hydraulic or pneumatic actuator, a horizontally opposed rotating imbalance, a cam and push rod, a piezoelectric transducer, an electric solenoid, or a stepper motor, as described above and in the below examples.

All cited documents are incorporated herein by reference in their entirety.

Methods and materials used to produce and evaluate the strength of vibration welded joints in accordance with the strategies proposed above will now be described.

Bulk Material

Bulk material used to examine the above strategies was 33% by weight glass-fiber-reinforced (i.e., 33% GF) and unreinforced nylon 6 (PA 6) and nylon 66 (PA 66) (DuPont Canada Corporation). The material was obtained as injection moulded plaques about 100 mm wide, irregular length, and 3.1 mm thick, in dry as moulded condition having been vacuum packed immediately after injection moulding. Each plaque was cut to a size of about 130 mm×100 mm, and then cut approximately in half, to provide two pieces about 130 mm×50 mm. All cuts were made with a mitre saw equipped with a blade designated for cutting plexiglass. The material was then vacuum packed in aluminum-lined bags to maintain a dry as moulded condition until needed for welding or tensile strength testing. The 130 mm moulded edges, rather than the cut edges, were joined during welding to best replicate conditions in industry, where welding occurs along moulded rather than cut surfaces. Length and thickness of the bulk materials was measured to determine the cross sectional area of the moulded edges and calculate the appropriate weld pressure, as known in the art.

Using a scanning electron microscope (SEM), it was found that fiber orientation of the injection moulded plaques along the moulded edge was not random, but rather in the direction of polymer flow, as discussed above.

Tensile Strength Testing of Unwelded Bulk Material

To assess changes in weld strength resulting from the various welding strategies employed herein, it was necessary to know the unwelded bulk material strength. The unwelded bulk strength of the unreinforced and glass-fiber-reinforced PA 6 and PA 66 material was measured in accordance with American Society for Testing and Materials (ASTM) D638, 1998. Tensile test pieces were cut from an injection moulded plaque in the traditional “dog bone” shape as is known in the art. Tensile strength was measured with a load applied in a direction perpendicular to that of the injection flow. This was done to allow for a direct comparison to the tensile strength of welded specimens, where the load was also applied in a direction perpendicular to that of the injection flow. All tensile testing was carried out with an Instron model 4202/5500R universal tensile testing machine (Instron, Canton, Mass.), with a cross head speed of 5 mm/min. The tensile strengths of the unwelded bulk materials are listed in Table 1. Strengths of the unreinforced materials are consistent with strengths reported in other studies. However, the reinforced material strengths are lower than the typical published data for these materials, due to the tensile load being applied in a direction perpendicular to the preferential fiber direction (discussed above). Normally, the reported strengths are measured by applying a load in a direction parallel to the direction of the reinforcing fibers and injection flow. Kagan 2001 reported that tensile strength and modulus of 33% GF PA 6 and PA 66 reaches a maximum value in the flow direction and up to 60% less in the transverse direction. This is consistent with the bulk strength findings presented here: for example PA 6 33% GF is reported to have a tensile strength of approximately 185 MPa (E.I. duPont de Nemours, 2001) with the load applied parallel to the injection flow direction, and in this work the strength is reported as 109 MPa.

TABLE 1
Tensile Strength of Unwelded Bulk Material. Average of
10 test pieces for each material.

| Material | Strength MPa (std. dev.) |
|---|---|
| Unreinforced PA 66 | 81 (0.7) |
| PA 66 33% GF | 129 (2.0) |
| Unreinforced PA 6 | 71 (0.7) |
| PA 6 33% GF | 109 (2.0) |

Tensile Strength Testing of Welded Material

As no universally accepted test standard exists to evaluate vibration-welded polymeric joints, a method was developed based on both ASTM D 638 (1998) and International Standards Organization (ISO) 527 (1994) standards for tensile testing unwelded polymeric specimens. A Universal Instron tensile testing machine was used, with a cross head speed of 5 mm/min, and the distance between grips was set to approximately 60 mm. The traditional “dog bone” shape was not used to test welded joints, since the failure was expected to occur in the weaker weld joint. Instead, 13 mm-wide test pieces were cut from the central portion of welded specimens. At least five test pieces were examined for all weld conditions. The tensile load was applied perpendicular to the weld plane and thus perpendicular to the direction of the injection flow. This is identical to the load direction during the tensile testing of bulk material. End pieces of the welded specimens were reserved for SEM work to view cross-sections of the welds.

Baseline Strengths of Welded Materials

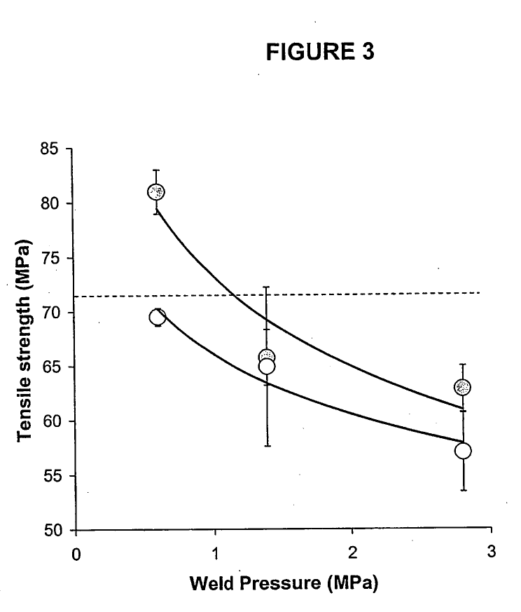

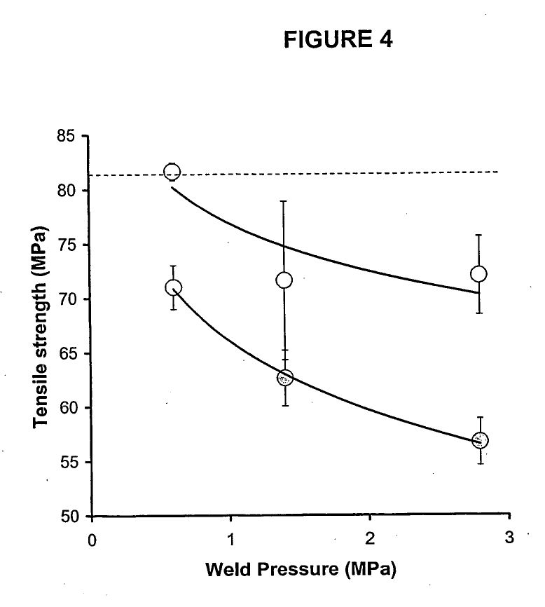

Tensile strength testing was performed on welded materials prior to any modification of the welding process, to establish baseline weld strengths. A Branson Mini II linear vibration welder (Branson Ultrasonic Corp., Danbury, Conn.) was used, with the following parameters: weld frequency of approximately 212 Hz, weld peak-to-peak amplitude of about 1.78 mm, target meltdown of about 2 mm, and weld pressure in the range of about 0.6 to about 2.8 MPa. For baseline welds, a hold time of 30 seconds was selected. For each condition, two sets of weld specimens were made. The results are provided as a function of weld pressure in FIGS. 3 and 4 for PA 6 and PA 66, respectively.

The tensile strength results agree with the general observation made by previous studies, in that strength decreases as the weld pressure increases. The weld strength of unreinforced nylon, at the lowest pressure, is generally equal to that of the resin matrix strength. The PA 6 33% GF weld strength surpassed the resin strength of PA 6 by 14% at the lowest pressure, but, as expected, fell far short of the unwelded bulk material strength of 109 MPa. The PA 66 33% GF fell far short of the unwelded bulk material strength of 129 MPa and, in fact, fell below its resin strength by 14%. The fracture surfaces of the baseline welds of FIGS. 2 and 3 were examined with a SEM for any differences between PA 6 33% GF and PA 66 33% GF. The SEM studies revealed decreasing randomness in fiber orientation, for both materials, with increasing pressure. The PA 6 33% GF had more randomness in fiber orientation and less bundling of fibers in comparison to the PA 66 33% GF. The reasons for the difference in fracture surfaces between the two materials may be related to differences in Theological behaviour resulting in thicker molten films for the PA 6.

Provision of an Auxiliary Normal Force

Strategies 2a and 2b set forth above required that an auxilliary force substantially in the z-direction of the weld plane be applied to the molten film of the parts being welded. These strategies required that the z-direction force be provided as an elongational strain during phase IV or an oscillation of the molten film during phase III of the welding process (refer to FIG. 2). Various embodiments of a z-direction actuator by which a z-direction force can be provided are described in sections a to g, below. However, it will be appreciated that the invention is not limited to the examples of z-direction actuators described in sections a to g, below. These examples are based on modifying an existing vibration welder, such as a Branson Mini II linear vibration welder. This is a small, pneumatic, laboratory-type welder with relatively small capacity, in terms of clamping pressure, clamping frame size, and vibrating head power. However, the concepts presented herein can equally be applied to modification of other welders, such as large capacity hydraulic welders, of which the model VW-6UH welder available from Branson Ultrasonic Corp., is an example. Further, the concepts presented herein can also be applied to the design and construction of new welders.
a) In a pneumatic welder, a z-direction pneumatic actuator is inserted between the upper assembly and the moving platen of the welder, and uses the welder pneumatic system. The compressibility of air limits the frequency of oscillation, but frequency and amplitude can easily been varied.
b) In a hydraulic welder, a z-direction hydraulic actuator is inserted between the upper assembly and the moving platen of the welder, and uses the hydraulic system of the welder. The incompressability inherent in hydraulics provides for a wide range of oscillation frequency, and the frequency and amplitude of vibration can easily be varied.
c) A horizontally opposed rotating imbalance is installed onto the moving platen. In this system the centrifugal force generated by a rotating mass provides upward and downward forces. It is easy to manufacture and relatively inexpensive. A disadvantage of this embodiment is the inability to maintain an initial force for simple elongation, and the inability to alter the amplitude of vibration without changing the weights (imbalance). Frequency is easily varied by changing the speed of rotation.
d) A cam and push rod system is installed between the upper assembly and the moving platen of the welder. This system translates a rotating motion into a linear motion allowing a force to be applied to move the moving platen. Frequency is easily varied, but it is difficult to vary amplitude.
e) Piezoelectric transducers are installed under the lower fixture, or between the pneumatic cylinder cam and the moving platen of the welder. Multiple crystal layers can be used to achieve the desired z-displacement amplitude. An advantage of this system is ease in interfacing with a computer controller necessary to synchronize vertical motions.
f) Electric solenoids are installed between the vibrating head and the moving platen of the welder. Variation in frequency of vibration can be easily.
g) Stepper motors are inserted between the moving platen and the upper assembly of the welder. The steppers convert electrical pulses into discrete incremental mechanical motion, and thus provide excellent control of both frequency and amplitude over the required range.

The invention is further described by way of the following non-limiting examples.

### WORKING EXAMPLES

### Example 1

### Elimination of Overshoot During Phase IV

During phase IV of the welding process (i.e., the cooling phase), molten polymer continues to flow out of the molten film (i.e., overshoot) due to the continuing application of weld pressure, which reduces molten film thickness. In this experiment the weld pressure was removed immediately upon the cessation of vibration by reducing the hold time to 0, thereby eliminating overshoot.

A Branson Mini II welder was used with the following welding parameters: weld frequency of 212 Hz, weld peak-to-peak amplitude of 1.78 mm, and meltdown target of 2 mm. To assess the effect of hold time on weld strength, the hold time was varied in this study for a range of 0 to 30 seconds. The weld pressure was also varied over a range of 0.8 to 4 MPa. Only PA 6 33% GF and PA 66 33% GF materials were examined, as the objective was to improve upon their baseline weld strengths.

It was found that whether a low, medium, or high weld pressure was used, hold time had no significant effect on the weld strength of a butt welded joint, in either of the glass-fiber-reinforced PA materials. It was concluded that the elimination of overshoot in phase IV does not improve weld strength of fiber-reinforced polymers.

### Example 2

### Removal of Weld Pressure in Phase III

In this experiment the weld pressure was removed in phase III of the welding process, while continuing to vibrate the two Nylon parts, in an attempt to increase the molten film thickness.

For these tests, a Branson Mini II welder was used with the weld frequency, peak-to-peak amplitude, and pressure set at 212.5 Hz, 1.78 mm, and 0.6 Mpa, respectively. Preliminary studies indicated that this weld pressure was the lowest pressure that could be used to create a viable weld Joint. The welder was set to weld by time rather than by distance, and the weld times used were 6, 7, 12, and 20 seconds. Only PA 6 33% GF and PA 66 33% GF materials were examined, as the objective was to improve upon their baseline weld strengths.

In each weld of PA 6 33% GF the tensile strengths were dramatically reduced to values below 20 MPa. Some welds failed even as the samples were removed from the fixtures. As a result, no further testing with PA 66 33% GF was carried out.

SEM analysis of the fracture surfaces and cross section of the welds revealed that the deterioration of weld joint strength was due to the formation of voids in the joint. The formation of the voids was attributed to insufficient weld pressure causing insufficient heat generation between the Nylon parts during welding, such that the material in the molten film was partially solidified and (a) ripped during vibration, and/or (b) shrunk, wherein the partially solid material could not follow the shrinking film, and formed voids. It was concluded that removal of weld pressure during phase III does not improve weld joint strength of fiber-reinforced polymers.

### Example 3

### Modification of a Linear Vibration Welder for Z-Direction Movement Using Stepper Motors

A Branson Mini II welder was modified for z-direction movement using two model DC-44 stepper motors and a model DCI-4000-2M controller (Design Components Inc., Franklin, Mass.). These steppers have a 5 pitch lead screw and a 200 steps/rotation drive motor, allowing a resolution of 25.4 μm/step, or 12.7 μm/halfstep, with an accuracy of +/−0.01% of length traveled. The extent of travel of the stepper positioning tables was 5.08 cm in either a positive or negative direction. The stepper positioning table could operate at a frequency up to 2500 Hz at full steps or 5000 Hz at halfsteps.

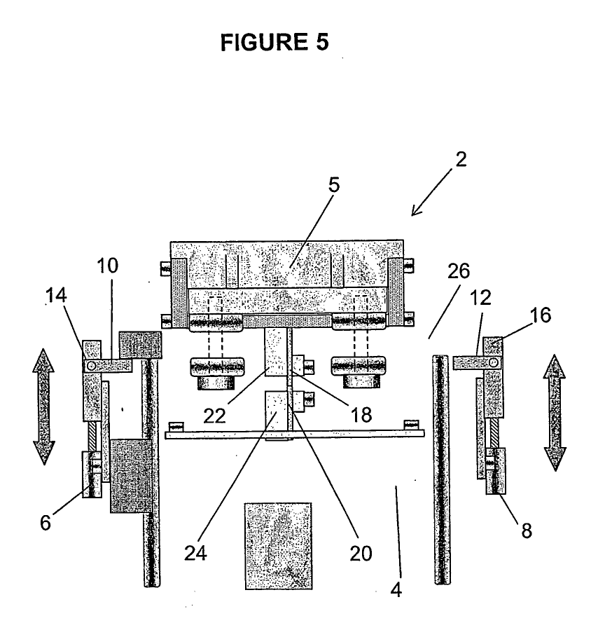

FIG. 5 is a schematic diagram of the Branson Mini II welder modified as described herein. Referring to FIG. 5, to induce z-direction displacement of the moving platen 4, and thus displacement of the lower polymer part 20 during welding, two stepper motors 6,8 were bolted to the moving platen 4 of the welder 2 using brackets 10,12 that were attached to the stepper positioning tables 14,16. The position of the brackets 10,12 in the z-direction with respect to the frame 26 of the welder was computer controlled.

Upper and lower parts 18,20 to be welded were mounted in their respective fixtures 22,24 and the moving platen 4 raised until the parts 18,20 made contact. The stepper positioning tables 14,16 were then pre-positioned such that the brackets 10,12 were a small specified distance (e.g., 0.3 mm to 1 mm) in the z-direction below the welder frame 26. The initial distance between the brackets and the frame is referred to as the trigger position.

During welding, the brackets travel upwards (positive z-direction) with the moving platen as meltdown occurs. After the trigger distance has been travelled, contact is made between the bracket and frame, as shown schematically in FIG. 5. At this instant, the stepper motors receive a signal to move their positioning tables and cause the brackets to push against the welder frame, thus forcing the moving platen downwards (negative z-direction) a specified distance. The result is a movement of the lower polymer part 20 away from the upper part 18 during welding. After a specified displacement, the stepper motor tables return to their original position, moving away from the frame and allowing platen to move back up. The cycle is then repeated a specified number of times. On the final cycle, the steppers are programmed to move farther away from the frame to allow the weld cycle to proceed as normal. This modification was used to cause an elongation of the molten film between the parts (Example 4) or an oscillation of the molten film (Example 5).

Although the steppers had a large range of frequency of oscillation, the frequency was limited by the transmission rate of the interface between the stepper controller and the data acquisition system, and the mechanical lag caused by the moving platen being driven upwards (positive z-direction) only by the pneumatic system of the welder. As a result, an oscillation frequency of 2.5 Hz was used.

### Example 4

### Elongation of the Molten Film at End of Phase III

In this experiment a strain normal to the weld plane was applied immediately at the end of phase III, in an attempt to reorient the reinforcing fibers in a direction normal to the weld plane. A Branson Mini II welder, modified as described in Example 3 was used, with a weld pressure of 0.6 MPa, so that results could be compared to the highest baseline weld strength. In addition, this lowest pressure was believed to have the highest molten film thickness based on preliminary studies. The weld frequency was set at 212.5 Hz, the weld peak-to-peak amplitude at 1.78 mm, and the meltdown at 2 mm. There was essentially no hold time as the elongation removed any weld pressure during cooling (phase IV).

The steppers were programmed to displace the moving platen over a range of distances from 190 μm (15 halfsteps) to 635 μm (50 halfsteps) with respect to the frame, and to move their positioning tables at speeds of 5080 μm/sec (400 halfsteps/sec). The steppers were triggered to move their positioning tables when the target meltdown was reached. The amount of elongation in the molten film resulting from negative z-direction movement of the platen was in the range of 40 to 500 μm. All of the terisile strengths of elongated PA 6 33% GF weld joints were dramatically reduced to values below 20 MPa, with some welds failing as they were being cut into tensile test pieces. As a result, this experiment was not carried out with PA 66 33% GF.

SEM analysis of the fracture surfaces of the weld joints indicated that large voids were created in the joints. The degradation of weld strength in all of the elongated weld joints was attributed to the voids and to fracturing in the bulk material in the vicinity of the weld. These defects were likely the result of elongating the molten film while it was rapidly solidifying. Preliminary studies had suggested that for these nylon samples the molten film solidifies within 200 to 400 msec, and in this experiment the duration of elongation was approximately 330 msec. Given that the stepper was set to travel 280 μm at a speed of 5080 μm/sec, the duration of elongation should have been closer to 55 msec. It is therefore likely that the steppers were not meeting their set acceleration rate due to the heavy inertial load of the platen. It is expected that with a faster rate of elongation, this method of introducing a strain normal to the weld plane to orient reinforcing fibers out of the weld plane would result in increased weld joint strength of fiber-reinforced polymers.

### Example 5

### Z-Direction Oscillation of the Molten Film During Phase III

In this experiment z-direction oscillations (i.e., oscillations normal to the weld plane) were introduced into phase III of the vibration welding process.

A Branson Mini II welder, modified as described in Example 3 was used, with a weld frequency of 212.5 Hz, weld peak-to-peak amplitude of 1.78 mm, target meltdown of 2 mm, the hold time of 30 secs, and stepper speed of 5080 μm/sec. The effect of five different variables on weld joint strength was examined: the number of cycles of z-direction oscillation (1 to 15); the amplitude of z-direction oscillation (40 to 500 μm); the trigger point of oscillations (1, 1.3, 1.7 mm of target meltdown); the weld pressure (0.6, 1.4, 2.8 MPa); and the material type (reinforced and unreinforced PA 6 and PA 66).

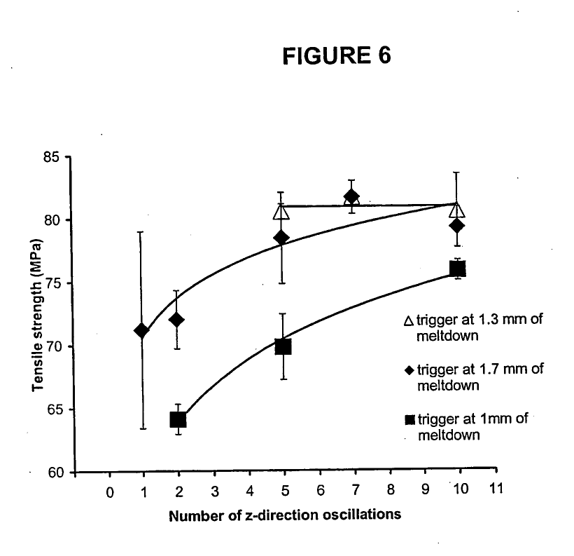

FIG. 6 shows the effect of number of z-direction oscillations and trigger point on the butt weld strength for PA 6 33% GF welded at a weld pressure of 1.4 MPa and a stepper amplitude of oscillation of 127 μm. It is clear that triggers close to the 2 mm target meltdown (1.3 mm or 1.7 mm) are preferred. Triggering sooner can be compensated by more oscillations. Triggering too soon or for an insufficient number of cycles may cause the upper vibrating part to erase any favourable orientation created by the oscillation.

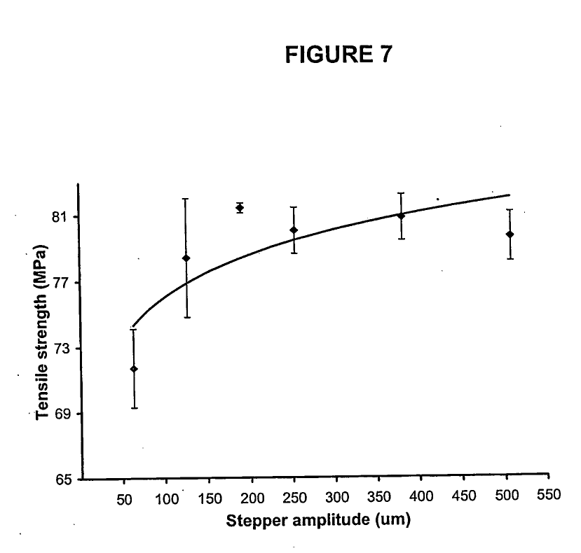

FIG. 7 shows the effect of the z-direction oscillation amplitude on butt weld strength for PA 6 33% GF welded at a weld pressure of 1.4 MPa and a trigger position of 1.3 mm. Strength increases up to amplitudes of 200 μm. In preliminary studies it was determined that because of the resilient mounts of the welder head, a weld pressure of 1.4 MPa caused the welder head to move upward (positive z-direction) a distance of approximately 100 to 150 μm. Therefore, the stepper oscillation amplitude downward (negative z-direction) must be greater than this amount to create an elongation on the molten film between the nylon parts. Thus, the higher weld strengths observed for oscillations greater than 100 μm can be attributed to the fact that the molten film was actually elongated during the oscillations.

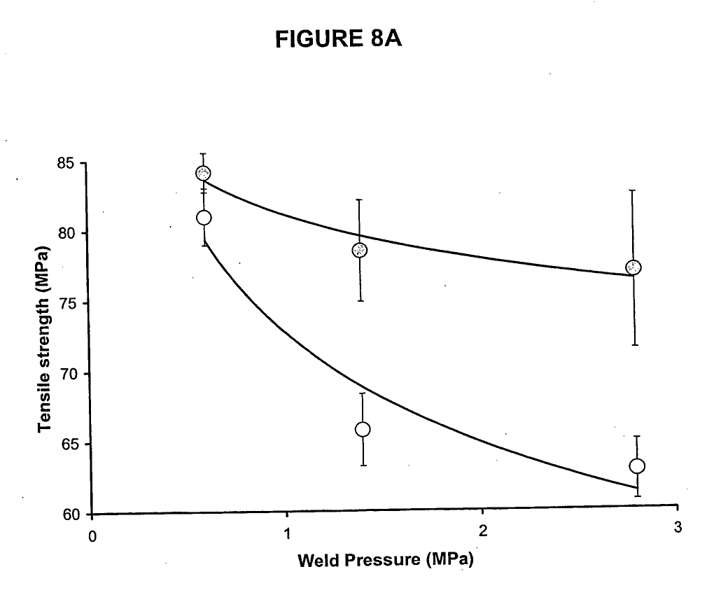

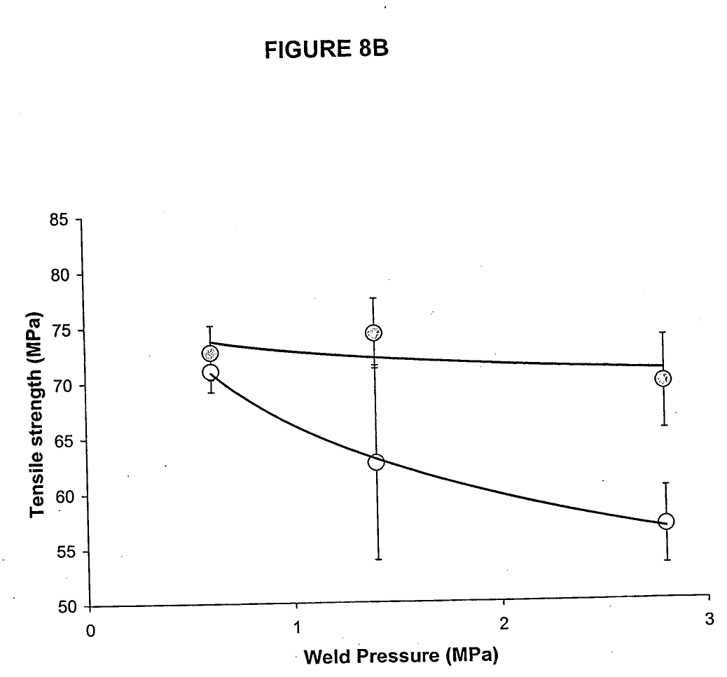

FIG. 8A shows the effect of oscillation (127 μm amplitude, 1.7 mm trigger point, 5 cycles) on butt weld strength of PA 6 33% GF as a function of weld pressure. Shown for reference is the strength-pressure profile observed for the standard vibration welding process. It is observed that oscillation raises weld strength more at higher weld pressures than at lower weld pressures. It is also observed that at high weld pressures, oscillations allow strengths to be increased to levels achievable under lower pressure using the traditional welding process. This suggests that the process of this example would allow low pressure-like weld strengths to be achieved without the cycle time penalty usually associated with low pressure welds.

FIG. 8B shows the effect of oscillation (127 μm amplitude, 1.7 mm trigger point, 5 cycles) on butt weld strength of PA 66 33% GF as a function of weld pressure. Again, results for the standard vibration welding process are shown for reference. Similar to PA 6 33% GF, z-direction oscillation increases butt weld strength significantly.

In both fiber-reinforced materials, oscillations did not improve upon the baseline weld strength at low weld pressure; however, at higher weld pressures weld strengths were improved. At 1.4 MPa weld pressure, the weld tensile strength was improved for PA 6 33% GF and for PA 66 33% GF by 19% and 18%, respectively. For a weld pressure of 2.8 MPa, weld strength improved by 23% over baseline strength for both materials.

SEM analyses of the fracture surfaces of the 1.4 MPa welds for both fiber-reinforced materials showed that the glass fibers were reoriented out of the weld plane when oscillated, such that the fibers were more randomly oriented in the weld plane after being oscillated. The change in glass fiber orientation was even more evident at the 2.8 MPa weld pressure

Unreinforced PA 6 and PA 66 were also subjected to this welding process to determine whether the increase in strength observed in fiber-reinforced material was strictly attributable to fiber reorientation, or whether the strength improvement was due to pressure cycling. However, the tensile strength results were inconclusive due to substantial variability in the data. It is probable that the unreinforced material has a smaller molten film thickness than that of the reinforced material. It is therefore possible that among the weakened specimens, the thin molten film had too high of an elongation, which destroyed the weld. Also, the compression of the oscillations might decrease the molten film thickness further, which would decrease weld joint strength.

Equivalents

Those skilled in the art will recognize or be able to ascertain, through routine experimentation, equivalents to the embodiments described herein. Such equivalents are within the scope of the invention and covered by the appended claims.

### REFERENCES

ASTM Committee on Standards, “Standard Test Method for Tensile Properties of Plastics” D638-97, American Society for Testing and Materials, 1998.
E.I. duPont de Nemours, “Zytel® nylon resin Product Information sheets”, DuPont Engineering Polymers, 2001.
Froment, I. D., “Vibration Welding Nylon 6 and Nylon 66—A Comparative Study”, Society of Plastics Engineers, Proceedings ANTEC '95, Boston, Mass., 1285-1289, 1995.
Gehde, M., Giese, M., Ehrenstein, G. W., “Welding of Thermoplastics with Random Glass Mat”, Polymer Engineering and Science, 37:702-714, 1997.
Giese, M., Ehrenstein, G. W., “Identification of Phase 3 in the Vibration Welding Process”, Society of Plastics Engineers, Proceedings ANTEC '93, New Orleans, La., 2058-2066, 1993.
International Organization for Standardization, “Plastics—Determination of Tensile Properties” ISO 527, 1994.
Kagan, V., Lui, S. C., Smith, G. R., “The Optimized Performance of Linear Vibration Welded Nylon 6 and Nylon 66 Butt Joints”, Society of Plastics Engineers, Proceedings ANTEC '96, Indianapolis, Ind., 1266-1274, 1996.
Kagan, V. A., “Forward to Better Understanding of Optimized Performance of Welded Joints: Local Reinforcement and Memory Effects of Polyamides”, Society of Automotive Engineers, Proceedings International Congress and Exposition, Detroit, Mich., paper 2001-01-0441, 2001.
Lee, J., “Vibration Welded Composite Intake Manifolds-Design Considerations and Material Selection Criteria”, Society of Automotive Engineers, Proceedings International Congress and Exposition, Detroit, Mich., paper 970076, 1997.
MacDonald, J. J., “The Vibration Welding of Engineering Plastics”, Published Master's Thesis, Royal Military College, Kingston ON., May 2001.
Potente, H., Uebbing, M., “Comparative Investigations into Welding of Glass-Fibre Reinforced PES”, Journal of Thermoplastic Composite Materials, 6:147-159, 1993a.
Potente, H., Uebbing, M., Lewandowski, E., “The Vibration Welding of Polyamide 66”, Journal of Thermoplastic Composite Materials, 6:2-17, 1993b.
Schlarb, A. K., Ehrenstein, G. W., “The Impact Strength of Butt Welded Vibration Welds Related to Microstructure and Welding History”, Polymer Engineering and Science, 29:1677-1682, 1989.
Stevens, S. M., “Characterisation of Nylon 6,6 Vibration Welds”, Society of Plastics Engineers, Proceedings ANTEC '97, Toronto, ON, 1228-1232, 1997.
Stevens, S. M., “Structure/Property Relationships in Polyetheretherketone Vibration Welds”, Society of Plastics Engineers, Proceedings ANTEC '99, New York, N.Y., 1360-1364, 1999.
Stokes, V. K., “Strength of Glass-Filled Modified Polyphenylene Oxide Vibration-Welded Butt Joints”, Polymer Engineering and Science, 31:511-518, 1991.
Stokes, V. K., “Vibration Welding of Thermoplastics. Part II: Analysis of the Welding Process”, Polymer Engineering and Science, 28:728-739, 1988a.
Stokes, V. K., “Vibration Welding of Thermoplastics. Part III: Strength of Polycarbonate Butt Welds”, Polymer Engineering and Science, 28:989-997, 1988b.
Stokes, V. K., “Vibration Welding of Thermoplastics. Part IV: Strengths of Poly(Butylene Terephthalate), Polyetherimide, and Modified Polyphenylene Oxide Butt Welds”, Polymer Engineering and Science, 28:998-1008, 1988c.

1. (canceled)

2. A method for increasing the strength of a particle-reinforced polymer weld joint, comprising:
providing a molten film of polymer at a weld plane of the joint; and
increasing randomness of orientation of all or a portion of the reinforcing particles in the molten film;
wherein said increased randomness of particle orientation increases the strength of the welded joint.

3-19. (canceled)

20. An apparatus for vibration welding a joint between particle-reinforced polymer parts, comprising:
a vibrator for vibrating at least one polymer part along a common interface of said polymer parts such that a molten film of polymer is provided at a weld plane of the joint; and
a z-direction actuator for compressing and elongating the molten film.

21. The apparatus of claim 20, wherein compressing and elongating the molten film reorients all or a portion of the reinforcing particles in the molten film such that a longitudinal axis of said reinforcing fibers is not parallel to the weld plane.

22. The apparatus of claim 20, wherein said z-direction actuator oscillates the molten film substantially perpendicular to the weld plane.

23. The apparatus of claim 20, wherein the polymer is selected from amorphous polymers, semi-crystalline polymers, and blends thereof.

24. The apparatus of claim 20, wherein the polymer is a polyamide selected from PA 6 and PA 66.

25. The apparatus of claim 20, wherein the reinforcing particle is selected from organic particles, inorganic particles, and a combination thereof.

26. The apparatus of claim 20, wherein the reinforcing particle is selected from carbon, kevlar, graphite, glass, ceramic, mineral, and a combination thereof.

27. The apparatus of claim 20, wherein the reinforcing particle is glass fiber.

28. The method of claim 2, wherein the molten film is provided by vibration welding.

29. The method of claim 28, wherein the molten film is provided by linear vibration welding.

30. The method of claim 2, wherein the molten film is provided by spin welding.

31. The method of claim 2, wherein the molten film is provided by hot plate welding.

32. The method of claim 2, wherein the molten film is provided by laser welding.

33. The method of claim 2, wherein the molten film is provided by resistance welding.

34. The method of claim 2, wherein the molten film is provided by induction welding.

35. The method of claim 2, wherein the reinforcing particles are reoriented by cycling weld pressure applied to said molten film.

36. The method of claim 2, wherein the reinforcing particles are reoriented by providing an oscillation to the molten film, the oscillation being substantially perpendicular to the weld plane.

37. The method of claim 2, wherein the polymer is selected from amorphous polymers, semi-crystalline polymers, and blends thereof.

38. The method of claim 37, wherein the polymer is an amorphous polymer selected from polystyrene, polyvinylchloride, acrylonitrile-butadienne-styrene, acrylonitrile-styrene-acrylic, polycarbonate, modified polyphenylene oxide, and polyetherimide.

39. The method of claim 37, wherein the polymer is a semi-crystalline polymer selected from a polyolefin, poly(butylene terephthalate), and a polyamide.

40. The method of claim 37, wherein the polymer is selected from modified polyphenylene oxide/polyamide blends, polycarbonate/acrylonitrile-butadiene-styrene blends, and polycarbonate/poly(butylene terephthalate) blends.

41. The method of claim 39, wherein the polymer is a polyamide selected from PA 6 and PA 66.

42. The method of claim 2, wherein the reinforcing particle is selected from organic particles, inorganic particles, and a combination thereof.

43. The method of claim 2, wherein the reinforcing particle is selected from carbon, kevlar, graphite, glass, ceramic, mineral, and a combination thereof.

44. The method of claim 2, wherein the reinforcing particle is glass fiber.

45. The method of claim 2, wherein increasing randomness of orientation of all or a portion of the reinforcing particles in the molten film comprises:
reorienting all or a portion of the reinforcing particles in the molten film such that a longitudinal axis of said reinforcing particles is not parallel to the weld plane.

46. The apparatus of claim 20, wherein compressing and elongating the molten film increases randomness of orientation of all or a portion of the reinforcing particles in the molten film.
